(19) United States
(12) Patent Application Publication
(10) Pub. No.: US 2012/0210403 A1
(43) Pub. Date: Aug. 16, 2012

(54) Mobile communications device-operated electronic access system

(75) Inventors: Georg Heidenreich, Erlangen (DE); Wolfgang Leetz, Uttenreuth (DE)

(73) Assignee: SIEMENS AKTIENGESELLSCHAFT, Munich (DE)

(21) Appl. No.: 13/369,461

(22) Filed: Feb. 9, 2012

(30) Foreign Application Priority Data
Feb. 10, 2011 (DE) 10 2011 003 920.1

(51) Int. Cl. G06F 21/20

(52) U.S. Cl. 726/6

(57) ABSTRACT

A mobile communications device is disclosed for use in an electronic access system for communicating with a central server for processing at least access authorization for an application running on the server. In at least one embodiment, an optical identification signal in the form of a barcode or a photographic recording of the user is captured on the mobile communications device in the form of an identification code and sent together with the mobile number to the server for further processing. The access authorization of the user for the respective application can therefore be verified on the central server. At least one embodiment relates in particular to medical and healthcare-related applications.

### PRIORITY STATEMENT

The present application hereby claims priority under 35 U.S.C. §119 to German patent application number DE 10 2011 003 920.1 filed Feb. 10, 2011, the entire contents of which are hereby incorporated herein by reference.

### FIELD

At least one embodiment of the present invention generally pertains to the fields of mobile communications and information technology and generally relates to a mobile communications device for processing a user-specific and application-specific access authorization for an application, a mobile communications device operated electronic access system, a server, and/or methods for processing at least one application-specific access authorization for diverse applications.

At least one embodiment of the present invention therefore generally relates to computer networks and/or data exchange between mobile communications devices which support different applications requiring an access authorization of the respective user, such as e-commerce or healthcare systems.

### BACKGROUND

Modern IT systems in the healthcare sector are generally computer-based, typically using smart cards, i.e. IC cards, as insurance cards, for example. However, as insurance is not the user's only application, the user nowadays carries with him a large number of such cards for a variety of applications, such as e-commerce or financial applications or the like. The IT background of such systems is generally based on the respective users being able to identify themselves with the card for the respective application, the card being employed, so to speak, as a user ID token.

Particularly in the healthcare area and its applications, there exist a large number of applications in which medical records have to be administered and collated, e.g. chronic diseases, examination reports, laboratory results, medical procedures and interventions, diagnostic image findings, medication data, etc.

The specific feature of the medical area is that life-threatening emergency events may occur which require immediate action. It has been found in practice that patients in such emergency situations often do not have with them the appropriate card with the access authorizations, or are unable to “use” it, which results in delays.

### SUMMARY

At least one embodiment of the present invention provides an information technology system which allows central but mobile user operation for different applications each requiring access authorization on the part of the user. In addition, medical emergency situations requiring user authorization should be practicable when users do not have their authorization card with them or are unable to use it.

In addition, the exchange of data between a plurality of clients (generally the patients) and at least one central server running the respective application or a plurality of applications is to be made more secure.

At least one embodiment is directed to a mobile communications device, a mobile communications device operated electronic access system, by a central server, by a method for processing an access authorization, both the client part of the method and the server part of the above mentioned method, and/or by a computer program product.

### BRIEF DESCRIPTION OF THE DRAWINGS

In the following detailed description, example embodiments not to be understood in a limiting sense together with their features and further advantages will be described with reference to the accompanying drawings in which:

FIG. 1 schematically illustrates electronic devices which interact according to an advantageous embodiment of the invention and

FIG. 2 schematically illustrates a mobile communications device operated electronic access system according to an example embodiment of the invention; and

FIG. 3 schematically illustrates data exchange between a mobile communications device and a central server according to an example embodiment of the invention.

The invention will now be explained in greater detail on the basis of different example embodiments described in conjunction with the drawings.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks will be stored in a machine or computer readable medium such as a storage medium or non-transitory computer readable medium. A processor(s) will perform the necessary tasks.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments may be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

Note also that the software implemented aspects of the example embodiments may be typically encoded on some form of program storage medium or implemented over some type of transmission medium. The program storage medium (e.g., non-transitory storage medium) may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

An aspect of at least one embodiment of the present invention resides in providing a scheme for operating a communication network (e.g. a mobile network) and an information technology platform based on a client-server solution with which the smart cards known from the prior art as a means of identification can be replaced by an electronic data record. At least one embodiment of the invention proposes using the respective user's mobile communications device. The mobile communications device is likewise used here to generate two identifying data records: on the one hand an electronic data record (identification code) is generated which uniquely identifies the respective user of the mobile communications device and, on the other, an electronic data record (device identifier) is generated which uniquely identifies the respective mobile communications device. The application can then—as recipient—of an identification message (sent by the mobile communications device user) validate a sender's access authorization for the application on the basis of the sender-identifying data record.

In an example embodiment of the invention, an image of the user is used as the user-identifying identification code and the mobile phone number is used as the device identifier. In alternative embodiments, the identification code can also be provided as an audible code or as an identification code in another format. Likewise, another identifier can be used as an alternative to the mobile phone number.

One aspect of at least one embodiment of the invention therefore relates to a mobile communications device for use in an electronic access system for communicating with a central server for processing at least one user-specific and application-specific access authorization for at least one application, comprising:

a generator for generating a machine readable identification code which in turn uniquely identifies a user of the mobile communications device;

a read-in module for reading in the machine readable identification code and

a transmit module which sends the machine readable identification code together with a device identifier in an identification message to the central server which is in turn designed to extract at least one application-specific and user-specific access authorization from the received identification message.

The terminology used in the context of embodiments of the invention will now be explained.

In an example embodiment, the mobile communications device is a commercially available mobile phone onto which an access authorization module has been loaded e.g. as a software application. Alternatively, the mobile phone can be equipped with a specific access module implemented as a hardware module. In addition to implementation as a mobile phone, other portable electronic devices can also be used, such as PDAs (personal digital assistants), laptops, portable computers or other electronic devices with appropriate interfaces. In the example embodiment, these devices or the mobile communications device used incorporate a camera in order to acquire image data. Alternatively, it is also possible for the mobile communications device to be implemented with an interface in order to exchange data with an image acquisition device (e.g. a digital camera) and read it in. The mobile communications device can exchange data with at least one central server, said data exchange preferably taking place via the mobile network. Alternatively, other communications protocols can also be used here. All the variants of embodiments of the invention mentioned below are basically applicable to other communication terminals, even if they are only described in connection with a mobile communications device.

The electronic access system comprises a central server. Depending on the type of application, a plurality of servers can obviously also be used in order to administer the respective applications. The applications are all characterized in that they can be operated and controlled only with a user-specific and application-specific access authorization. Particularly in the healthcare sector it is a mandatory requirement that patient data, for example, can only be viewed by an authorized person (generally the patient in question and the treating physician). To this end, in the prior art the respective users (patient and/or doctor) carry a specific token with them which in most types of application is implemented in the form of a smart card. The smart card holds one or more data records for uniquely identifying the respective user. According to an example embodiment, the server is designed to execute the respective application (or the plurality of applications). In other words, the respective applications run on the server and only the input data records and/or the output data records are transmitted to the respective client (i.e. to the mobile communications device).

An example of such an application is the administration of insurance data for a patient. For example, depending on the application, the patient's insurance data records are sent to the application in order to record a medical examination using the respective insurance data. Likewise, new terms of insurance cause insurance data to be transmitted from the application to the client. In the latter case, the data is stored on the chip of the memory card so that it can be retrieved again for subsequent use. It is likewise possible for the application to be implemented in a distributed manner and to be executable partly on the central server and partly on the client of the mobile communications device. It is likewise obvious that the application, the central server and/or the mobile communications device interact with other electronic or computer-based instances or modules in order to transmit access authorization data.

The machine readable identification code is preferably generated directly on the mobile communications device itself. The identification code is characterized in that it uniquely identifies the user (here: the user of the mobile communications device). The identification code is machine i.e. computer readable and comprises at least one of the following data records: user name, user's date of birth, place of birth, e-mail address or other data records which uniquely identify the user and are basically invariant apart from the optional additions of modifiable portions, such as e.g. a time stamp. The mobile communications device preferably has a software module loaded which is designed, among other things, to generate said identification code, read it in and collate it quickly, reliably and securely with another data record. Accordingly, the read-in module is implemented as a constituent part of the generator. Alternatively, the identification code can also be generated not on the mobile phone but e.g. by the mobile network—or communications network operator. The read-in module is then used to read in the remotely generated identification code. The other data record is a device identifier.

The device identifier is likewise a machine i.e. computer readable code which is used to uniquely identify the user. The device identifier is preferably constituted by the mobile number of the respective mobile communications device. The device identifier therefore uniquely identifies the user (client) of the mobile communications or network device (generally via its SIM card). If a plurality of users communicate with or use the same mobile phone number, further items are accordingly added to the device identifier in order to make all the users of these numbers differentiable.

It is likewise possible to use a plurality of mobile numbers as a device identifier, each mobile number uniquely identifying a user. In an alternative embodiment, the mobile communications device manufacturer's serial number can also be used alternatively or additionally to the mobile number if it uniquely identifies the respective mobile communications device. The device identifier can preferably be generated directly from the mobile communications device itself without further user interactions or an exchange of data with other instances being necessary.

The identification message can be a digital signal which is likewise generated on the mobile communications device. The identification message is usually a combination of the machine readable identification code and the machine readable device identifier. In alternative embodiments, the identification message also comprises other elements such as a time stamp in order to be able to time-resolve the identification message also at a later point in time. The identification message is preferably created automatically and without further user interaction in machine readable form on the mobile communications device. In alternative embodiments, yet more security measures can be applied to the identification message. For example, the identification message as such or parts thereof can be subject to encryption so that they can only be transmitted in encrypted form to the server which then decrypts them again—being in possession of the necessary encryption information.

An important aspect of an embodiment of the present invention is that an optical code is used as the identification code for identifying the mobile user, using here the image data which uniquely identifies the user. This includes a photograph of the user or other optical code assigned to the mobile user in a preparatory phase. A barcode can be used here, for example. In a subsequent step the optical code used is captured using a camera associated with the mobile communications device (photograph of a reproduced barcode or photograph of the mobile user or a combination of the two).

According to an embodiment of the invention there is implemented on the mobile communications device a module which generates a digital signal from the optical signal(s) captured. For example, this can be an optical recognition measure, such as an optical character recognition (OCR) method known from the prior art, or similar. In other words, it is therefore inventively provided to transform an optical, analog signal (the image acquired) into a digital signal (the identification code). It is preferably provided that the digital identification code is transmitted from the mobile communications device to central server where it is resolved.

As already explained above, yet more security measures can obviously be applied here, so that the identification code is not communicated directly to the central server, but only an encrypted image thereof. It is likewise possible to transmit the identification code via a plurality of intermediate points and therefore only indirectly to the central server if, for example, yet more applications and actions have to be executed on the basis of the identification code.

The identification code is preferably captured using an optical capture device associated with the mobile communications device. This is usually a camera, e.g. a CCD camera (comprising charge coupled device sensors). It is of course likewise possible to capture the identification code using some another electronic device and transfer it via an interface to the mobile communications device for forwarding to the transmit module so that it can be sent together with the device identifier. Alternatively, the identification code can also be read in by another application or another computer-based instance and transmitted to the mobile communications device via an interface.

As already mentioned above, the mobile communications device comprises at least one generator or a read-in module and a transmit module. These are preferably software applications and/or hardware modules.

The transmit module can be operated in two different modes:
in push mode and
in pull mode.

Push mode is characterized in that in the case of a predefinable event on the part of the mobile communications device (for example: switch-on of the mobile communications device, newly generated or changed identification code and/or device identifier, etc.), transmission of the identification message to the central server is initiated automatically. Pull mode is characterized in that transmission of the identification message is triggered by a server event. In particular, transmission of the identification message is initiated if the server or more specifically an application running thereon requests identification data. In both variants it can be provided that a verification signal must be detected in order to send the identification message. The verification signal usually requires acknowledgment by the mobile user. This aspect enables the security of the system to be increased, as no identifying data is sent from the mobile communications device to the central server or to other instances unless the mobile user acknowledges.

In an example embodiment it is provided that the optical identification code is transmitted as a multimodal message, in particular using the multimedia messaging service (as MMS). In alternative embodiments, however, other data formats and transmission protocols can be used.

An advantage of at least one embodiment of the inventive solution is that, for communication using the mobile communications device, a code (generally the mobile number) identifying the mobile communications device is transmitted anyway. This data record is used to generate the identification message or to extract the identification code from the identification message at the server end, as the case may be.

The advantage is therefore that no additional information technology measures or upgrades, or only minor ones, are necessary on the mobile communications devices. Moreover, no significant additional user interactions are necessary, so that the method for processing the access authorizations can be executed automatically to a very large extent. For medical use it is found particularly advantageous that the coding (the identification code) identifying the respective patient can also be read in even if the mobile users for medical reasons or due to illness are unable to enter the identification code themselves.

Another advantage of at least one embodiment is also that the types of application are not limited to the medical sector, but can also be basically used, for example, in other areas such as in the insurance, financial or e-commerce fields using applications in which a user likewise has to provide authorization on an application-specific basis (as has hitherto always been done via the use of an IC card and reading-in of the respective data records to the IC chip). An advantage is also that the nature and content of the respective application is basically independent of the inventive solution. Consequently, the applications can also be extended. For example, it is also possible for the server, after receiving the identification message and extracting the identification code, to receive yet more data records from the client (i.e. the mobile communications device) and for these to be processed on the server.

The parameters that are to be taken into account for determining the identification code can be defined in advance. For example, it is possible here to take only the user name and date of birth into account. However, it is also possible here to use yet more of the above mentioned data records. It is also possible for the configuration parameters, such as the identification code definition, to be changed even during ongoing operation. Thus, for example, the user's e-mail address or other identifying data records such as bank access data can be taken into account.

In an example embodiment, the generator, the read-in module and the transmit module can be incorporated in the mobile communications device in a single module. Alternatively, these can also be implemented as separate modules in the mobile communications device, thereby enabling them to be changed independently of one another. They are usually realized in applet form here.

Another solution for achieving the above object resides in a mobile communications device operated (or network device operated) electronic access system for processing at least one access authorization for at least one application. The access system comprises a plurality of mobile communications devices (or network devices) and at least one central server with which the mobile communications devices are in data communication (preferably via the mobile network). Here a mobile communications device is associated with a user in each case so that the user can therefore be uniquely identified via the mobile communications device. The mobile communications device is additionally identifiable via a machine readable device identifier. The mobile number is preferably used here. Alternative embodiments here provide other identification possibilities for the mobile communications device (e.g. manufacturer identification code or an ID code assigned in a preparatory phase).

In an example embodiment, the access authorization is both application-specific and user-specific. This means that a particular user requires an individual and separate access authorization for a particular application in each case. With the solution according to an embodiment of the invention, the cards hitherto used in the prior art for operating the respective applications (for example, a card for operating an insurance application and another card for operating a medical application) are replaced by using a single mobile communications device having the inventive additional functionality.

As already mentioned, the access system according to an embodiment of the invention is characterized among other things in that a machine readable identification code is generated or read in on the mobile communications device and then sent together with the device identifier, which is likewise machine readable, in an identification message to the central server via the mobile network and with the terminal address of the application (e.g. mobile number or e-mail address). The server can then extract at least one application-specific access authorization from the received identification message and control or operate the application therewith. The user only interacts with his mobile communications device via the user interface provided. Interaction of the mobile communications device user with the central server is not provided, nor is it necessary.

With an embodiment of the invention it is now possible for the mobile user to be uniquely identified at the server end and this data to be stored in a database or made available to other instances.

Another embodiment is directed to a method for processing an access authorization. Here generation, reading-in and transmission are carried out on the mobile communications device, while receiving and extraction are carried out on the central server.

An embodiment also resides in a client-side method which is carried out on the mobile communications device and is designed for interaction with the central server, and in a server-side method for operating a server, said method being designed for interaction with the mobile communications device.

An alternative solution of at least one embodiment resides in a computer program product. The computer program can also be stored on a data carrier or a storage medium. It is likewise possible to provide the computer program as a distributed system, so that individual modules can be executed in the mobile communications device and other modules can be run on the central server.

An alternative solution of at least one embodiment resides in a computer-implemented method which can also be marketed in the form of a program stored on a storage medium.

Further solutions and alternative embodiments are set forth in the relevant claims.

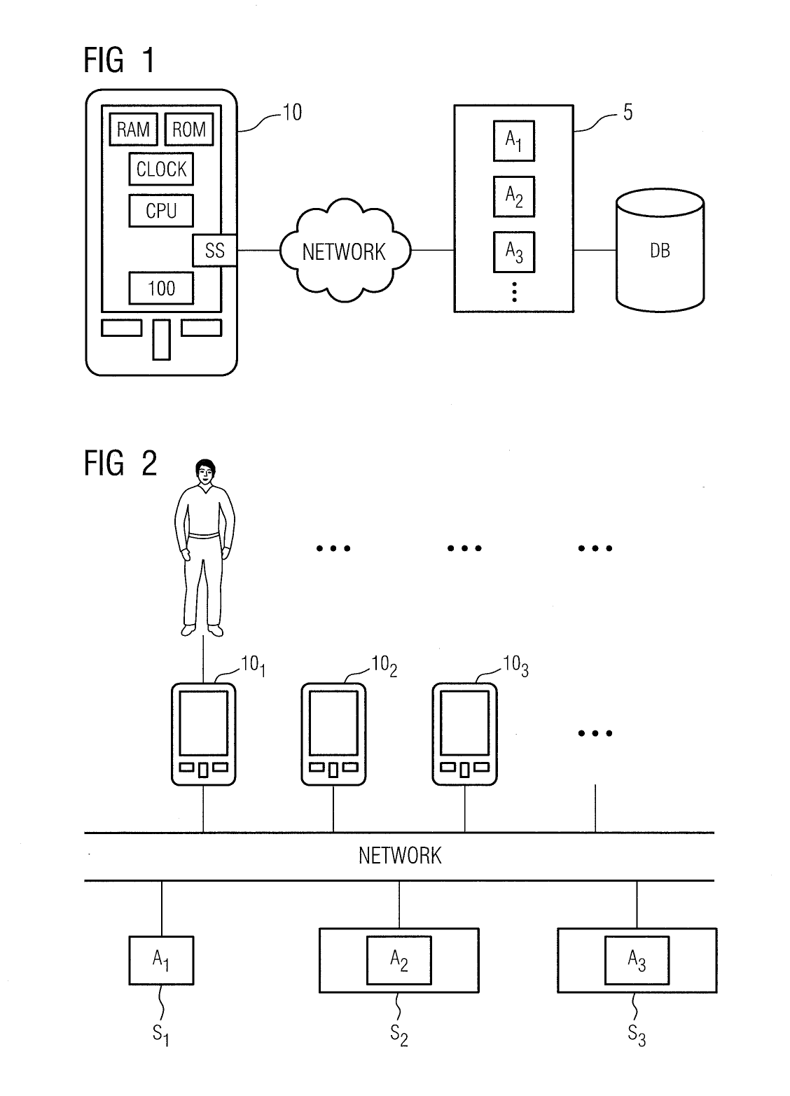

FIG. 1 shows a schematic overview of a mobile communications device 10 which is in data communication with at least one central server S via a mobile network (uniformly termed “network” in the figures). The mobile communications device 10 can be a commercially available mobile phone or smartphone comprising different memories (RAM, ROM), an operating system OS, a clock generator CLOCK, a processing unit CPU and generally a plurality of interfaces SS, the latter including a graphical user interface, generally in the form of a touch screen.

The mobile communications device 10 comprises a module 100 in which further modules are incorporated. The module 100 is an access module designed to compute and process access data.

The server S is a computer-based instance which can include a computer or a computer network or a cloud computing system which interacts with other computer-based instances such as a database DB, for example. The server S inventively incorporates at least one application A which in turn comprises a plurality of modules.

As a mobile communications device 10, it is inventively provided to use a normal commercially available mobile communications device 10 on which a software or hardware applet is loaded or implemented. The applet can be provided in the form of a single module 100 or can be of modular design with individual separate modules 101, 102 and 103, etc. which are implemented on the mobile communications device 10.

FIG. 2 is a schematic overview showing that, in the access system according to the invention, a plurality of mobile communications devices 101,102, 103, 104 . . . are generally in mutual data exchange via a mobile network with a plurality of servers S. In an alternative embodiment it is also possible to provide a single central server S. On the server S different applications A1, A2, A3, etc. can be implemented which are designed to process and compute access data. The assignment between application and server is unlimited. Thus it is possible for a single application to run on a server or for a plurality of applications (for an application in the general sense) to be distributed over a plurality of servers. For example, an image reading application for reading patient-specific image examination data, a post-processing application for post processing of an image dataset, an access application for authenticating the user, etc.

As indicated in FIG. 2, the different servers S can be implemented with the same applications Ai or with different applications A in each case. The servers S are in data communication via a network. The network is usually a computer network which can be operated in accordance with different protocols.

A mobile communications device 10 is usually operated by just one operator or user. This is indicated in FIG. 2 by the assignment between the schematically illustrated user and the respective mobile communications device 10. Alternatively, n:m assignments can also exist.

According to an example embodiment, the server S with the applications A1, A2, A3 . . . is assigned to the mobile network operator, thereby providing data communication between the individual mobile communications devices 10 and the respective applications A on the server S. In an alternative embodiment, the server S with the applications A is not part of the mobile network operator's computer center but is provided as a separate server S. In this case the mobile network operator creates an interface to the server S which ensures data exchange. Consequently, a server S which is provided as a separate instance can also interact indirectly with the mobile communications devices 10 of the system via interfacing circuitry of computer-based instances of the mobile network operator.

According to one aspect, an embodiment of the invention relates to the fact that a user having a plurality of smart cards for different applications or more specifically applications A can now use or more specifically control the different applications A solely via a common and to a very large extent automated access authorization using his mobile communications device 10, without having to use the individual smart cards, as has hitherto been necessary in the prior art. In particular, the use of two different codings (first in respect of the mobile communications device 10 and second in respect of the user) is designed to allow application-specific and user-specific verification of the access authorization.

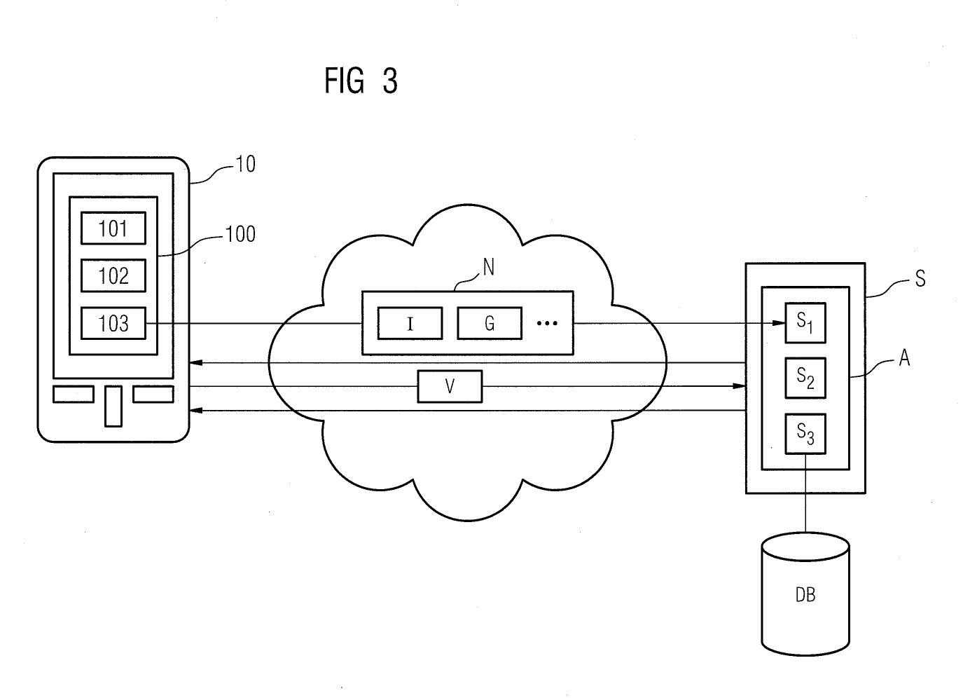

An embodiment of this inventive approach will now be explained in greater detail on the basis of exemplary embodiments in conjunction with FIG. 3.

According to an embodiment of the invention it is therefore provided that the mobile communications device 10 is provided with an additional applet 100. The central server S likewise provided with an additional application A. In an alternative embodiment of the invention, the application A is provided anyway and is only augmented by additional modules.

The mobile communications device 10 is preferably augmented by a generator 101 for generating a machine readable identification code I, said identification code I uniquely identifying the respective mobile communications device user.

In an alternative embodiment, a read-in module 102 is provided which is likewise implemented on the mobile communications device 10 and is designed to read in the identification code I which has been generated on another instance.

In addition, a transmit module 102 is provided on the mobile communications device 10. The transmit module 102 us used to create an identification message N. The identification message N preferably comprises the machine readable identification code I and a device identifier G. The device identifier G uniquely identifies the respective mobile communications device 10.

According to an example embodiment, the identification code I is a data record which uniquely identifies the user. A combination of individual i.e. person-specific data records is used for this purpose, such as, for example, the user name, date of birth, location, e-mail address, an image of the user, etc. An image of the user is preferably used here. The image of the user is acquired by the mobile communications device 10 using a built-in camera and transmitted to the server S in digitized form together with the device identifier G as an identification message N. The mobile number of the mobile communications device 10 is preferably used for the device identifier G. As the mobile number G is used anyway for communication of the mobile communications device 10, the addition of the device identifier G in the form of the mobile communications device number takes place in any case and is so to speak carried out automatically without modification of the existing system. In alternative embodiments, the identification message N can include yet more data records, such as a time stamp and the like. The identification message N is transmitted to the server S via the mobile network.

The server S incorporates a plurality of applications A. These are software and/or hardware modules. The server S in particular comprises a receive module S1 for receiving the identification message N. It also comprises an extractor S2 designed to extract the identification code I from the identification message N received. The server S also incorporates a linker S3 for electronically linking the identification code I with the device identifier G in order to operate and/or control the respective application A. Said application A can also be in data communication with a database DB which is likewise shown in FIG. 3.

As shown in FIG. 3, the generator 101, the read-in module 102 and the transmit module 102 are implemented on the mobile communications device 10 or assigned thereto. In contrast, the receive module S1, the extractor S2 and the linker S3 are assigned to the respective application A and implemented on the server S.

The typical sequence of a method for processing access authorizations can also be explained with reference to FIG. 3.

First, the identification code I which uniquely identifies the user of the mobile communications device 10 is generated at the mobile communications device end by means of the generator 101.

In a second step, the identification code I generated is read into the mobile communications device 10 by the read-in module 102.

In a third step, an identification message N is generated which includes the identification code I read in and the device identifier G. This is performed by the transmit module 102. Alternatively, this function can also be executed on the read-in module 102 which then forwards the result to the transmit module 103. In a subsequent fourth step, the transmit module 102 sends the thus generated identification message N to the central server S via the mobile network.

The receive module S1 of the server S receives the identification message N and automatically forwards it to the extractor S2. The extractor S2 extracts from the received identification message N the identification code I which actually identifies the user of the mobile communications device 10. It is therefore possible on the part of the server S to ascertain which person has sent the respective message and to make this information available to the application A and/or other computer-based instances and modules. The linker S3 is now used to electronically link the identification code I with the device identifier G from the received identification message N in order thereby to operate and/or control the application A.

According to an aspect of an embodiment of the invention it is provided that the target application A which is to be activated is determined when the identification message N is transmitted by the mobile communications device 10. Here it is preferably provided that each of the different applications A has its own mobile number (or in the case of another communication network: its own terminal address) so that the user of the mobile communications device 10 can determine the recipient of the identification message N by dialing the respective number. The mobile communications device therefore, so to speak, calls the application. The phone numbers can be stored in a SIM card directory for this purpose. This will be explained in more detail in the following example.

A user is in possession of a smart card for a first field of application “e-commerce” and is also in possession of a second smart card for a second field of application “health insurance card”. In the prior art, if the user wanted to carry out an Internet transaction and then had to visit the doctor which required communication of his health insurance data, it has hitherto been necessary for the user to use his first e-commerce smart card and then his second health insurance smart card. With the solution according to an embodiment of the invention this is now no longer necessary. Instead, the user now only needs to use one device, namely his mobile communications device 10. For the first field of application, he sends the image identifying him which he captures using the camera of his mobile communications device 10 (or has already captured and retrieves from the memory), stating his mobile number (which is used as device identifier G), to the e-commerce application A. The e-commerce application A can then check the user's identity and can initiate a data exchange for the desired purchase. Then, or at the same time, the user can send the image identifying him (which is again used as the identification code I) to another mobile number, again with disclosure of his mobile number, which is likewise used as a device identifier G. The second number addresses the second application, namely the health insurance application.

Therefore if the user is asked for his health insurance data in connection with his medical consultation, it is no longer necessary for him produce his health insurance card. Instead, he only needs to send the image identifying him to the health insurance application A which then analyzes the required data for validating the access authorization. In an alternative embodiment of the invention, data exchange between the applications can be provided so that the identification data is sent automatically and directly from the first to the second or another application without the user having to retransmit his ID data for this purpose. To increase security for transmitting his ID data to another application, an acknowledgment signal can optionally be requested from the user.

An advantage is therefore also to be seen in that the user can effectively use a plurality applications A in parallel, all requiring an (in each case different) access authorization.

As shown in FIG. 3 and mentioned above, it is possible according to an alternative embodiment to make the transmission of the identification message N and/or the transmission of application-specific data A from the server S to the mobile communications device 10 dependent on an acknowledgment signal and/or a verification signal V on the part of the user. As can be seen in FIG. 3, the further processing on the server S by the application A can also be made dependent on receipt of the verification signal V. In this case it is therefore waited until the mobile communications device 10 sends a verification signal V to the server S. The users of the mobile communications device 10 can therefore make the further processing of the access data on the server S dependent on entry of their acknowledgment signal. All in all, the security of the system can be increased by ensuring that identifying messages or data records are only transmitted between the mobile communications device 10 and the server S or more specifically the application A if the user also acknowledges accordingly.

As already mentioned above, the invention relates in the example embodiments to the use of an optical identification code, there being two advantageous embodiments here: on the one hand, the use of an image or more specifically a camera recording of the respective user and, one the other, the use of a barcode which uniquely identifies the respective user and which in a further step is photographed by the camera of the mobile communications device 10 and can therefore be forwarded in digitized form.

The photograph of the user can be taken by the camera at the time or can be present in stored form. The advantage of this solution is that user does not need to carry any additional identification features with him. In the case of using the barcode it is merely necessary to carry the barcode with him in a selectable format. For example, the barcode can be printed on paper or can already be provided in stored form in the mobile communications device 10. The visual representation of the barcode is then photographed and thus digitized and can therefore be forwarded to the other instances.

In both variants the optical identification code I (barcode or image of the user) is photographed and transmitted in digital form, preferably in an MMS, to the server S to operate the applications A.

To summarize, an embodiment of the invention may be briefly described as follows: photographic data acquisition of an optical identification code, in the form of an image of the user or in the form of a barcode, is obtained on the mobile communications device 10 and is used to identify the user. Said optical identification code I is sent together with the mobile number G of the mobile communications device 10 as an MMS to an application A which is running on a central server S and which, on receipt of the identification message N, is able to identify the sender of the identification message N (namely the user) and assign corresponding data records in order to operate the application A. Using an optical identification signal (photographic recording of a barcode or of the user) and the user's mobile number, server-side identification of the user for the respective application A can take place.

Lastly it is pointed out that the different example embodiments mentioned in the above description can also be used in combination. Moreover, it is possible to carry out parts of the method for processing an access authorization on the mobile communications device 10 and other parts of the method on the server S, so to speak as a distributed system or according to a client-server principle whereby a plurality of mobile communication clients 10 interact with a central server S which can in turn incorporate a plurality of applications A. Although the main field of application of an embodiment of the invention is in the medical and healthcare areas, the access authorization principle proposed here can also be applied to other technical fields likewise requiring access authorization of the part of the user. In addition, a combined use in different areas is possible (e-commerce, financial sector, healthcare, etc.), for which the user only needs to carry with him his mobile communications device 10 and the optical identification code identifying him.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a tangible computer readable medium and is adapted to perform any one of the aforementioned methods when run on a computer device (a device including a processor). Thus, the tangible storage medium or tangible computer readable medium, is adapted to store information and is adapted to interact with a data processing facility or computer device to execute the program of any of the above mentioned embodiments and/or to perform the method of any of the above mentioned embodiments.

The tangible computer readable medium or tangible storage medium may be a built-in medium installed inside a computer device main body or a removable tangible medium arranged so that it can be separated from the computer device main body. Examples of the built-in tangible medium include, but are not limited to, rewriteable non-volatile memories, such as ROMs and flash memories, and hard disks. Examples of the removable tangible medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A mobile communications device for use in an electronic access system and for communicating with a central server for processing at least one user-specific and application-specific access authorization for at least one application, comprising:
a generator configured to generate a machine readable identification code which identifies a user of the mobile communications device;
a read-in module configured to read in the machine readable identification code; and
a transmit module configured to send the machine readable identification code, together with a device identifier in an identification message, to the server which is able to extract at least one application-specific access authorization from the identification message.

2. The mobile communications device as claimed in claim 1, wherein the identification code is an optical code and is transmitted as at least one of a barcode and an image.

3. The mobile communications device as claimed in claim 1, wherein the identification code is generated using an optical capture device which is assigned to the mobile communications device or is incorporated therein or which is read in via a data interface.

4. The mobile communications device as claimed in claim 1, wherein the identification message is transmitted in a packet and optionally includes a time stamp.

5. The mobile communications device as claimed in claim 1, wherein the identification message is transmitted as a multimodal message.

6. The mobile communications device as claimed in claim 1, wherein the device identifier is generated automatically from the mobile and is automatically added to the identification message.

7. A mobile communications device operated electronic access system for processing at least one user-specific and application-specific access authorization for at least one application, comprising:
a plurality of mobile communications devices; and
at least one server, each of the plurality of mobile communications devices being assigned to a user and being identifiable via a machine readable device identifier, wherein on each of the mobile communications devices, an electronic identification code identifying the mobile communications device user is adapted to be generated, read in and sent in an identification message together with the machine readable device identifier to the at least one server which is able extract at least one application-specific access authorization from the received identification message.

8. The mobile communications device operated electronic access system as claimed in claim 7, wherein each of the mobile communications devices and the at least one server are in data communication via a mobile network.

9. A central server for use in the mobile communications device operated electronic access system as claimed in claim 7, comprising:
a receive module configured to receive the identification message;
an extractor configured to extract the identification code from the received identification message; and
a linker configured to electronically link the identification code to the device identifier in order to control the application.

10. The central server as claimed in claim 9, wherein a result of the linker is stored in a database or is made available to other instances.

11. A method for processing at least one user-specific and application-specific access authorization for at least one application, said method being carried out on a plurality of mobile communications devices and on at least one server, wherein each of the mobile communications devices is assigned to a user and wherein each of the mobile communications devices is identifiable via a machine readable device identifier, the method comprising:
generating a machine readable identification code which identifies the user;
reading the generated identification code into a respective one of the mobile communications devices;
sending an identification message comprising the identification code read in and the device identifier from the respective mobile communications device to the server, the identification message being receivable at the server and the identification code being extractable from the identification message, at least one application-specific access authorization for controlling the application being useable to extract the identification code, and the identification code being electronically linkable with the device identifier.

12. A method for a mobile communications device for processing at least one user-specific and application-specific access authorization for at least one application, wherein the mobile communications device is in data communication with at least one server, wherein the mobile communications device is assigned to a user and wherein the mobile communications device is identifiable via a machine readable device identifier, the method comprising:
generating a machine readable identification code which identifies the user;
reading the generated identification code into the mobile communications device; and
sending an identification message containing the read in identification code and the device identifier from the mobile communications device to the at least one server.

13. A method for operating a server for processing at least one user-specific and application-specific access authorization for at least one application, wherein the server is in data communication with a plurality of mobile communications devices, wherein each of plurality of mobile communications devices is assigned to a user and wherein each of the plurality of mobile communications devices is identifiable via a machine readable device identifier, the method comprising:
receiving an identification message from one of the plurality of mobile communications devices, containing a machine readable identification code and a device identifier of the one of the plurality of mobile communications devices, wherein the identification code identifies the user of the one of the plurality of mobile communications devices; and
extracting the identification code from the identification message in order to extract from the identification code at least one application-specific access authorization for controlling the application, and electronically linking the extracted identification code with the device identifier.

14. A computer program product comprising a computer program stored on a machine readable media for carrying out the method as claimed in claim 11 when the computer program is executed on a computer.

15. The mobile communications device as claimed in claim 4, wherein the identification message is transmitted in response to a verification signal.

16. The mobile communications device as claimed in claim 5, wherein the identification message is transmitted as a multimodal message using the multimedia messaging service.

17. The mobile communications device as claimed in claim 6, wherein the device identifier is the mobile number of the device and is automatically added to the identification message.

18. A computer readable medium including program segments for, when executed on a computer device, causing the computer device to implement the method of claim 11.

19. A computer readable medium including program segments for, when executed on a computer device, causing the computer device to implement the method of claim 12.

20. A computer readable medium including program segments for, when executed on a computer device, causing the computer device to implement the method of claim 13.
